(19) United States
(12) Patent Application Publication
(10) Pub. No.: US 2025/0213891 A1
(43) Pub. Date: Jul. 3, 2025

(54) ROPE ACCESS DEVICE

(71) Applicant: FALLPROTEC, Grass (LU)

(72) Inventors: Francis TIMMERMANS, Steinsel (LU); Yang WU, Luxembourg (LU)

(21) Appl. No.: 19/002,330

(22) Filed: Dec. 26, 2024

(30) Foreign Application Priority Data
Dec. 29, 2023 (LU) LU 505 953

(51) Int. Cl. A62B 1/14

(52) U.S. Cl. CPC A62B 1/14

(57) ABSTRACT

The application provides a rope access device for moving along a rope including a frame having, in service, a first region facing toward a portion of the rope under tension, a grip pulley mounted on the frame and including on the periphery thereof a groove enabling the rope to be hauled by grip, the grip pulley being coupled to rotational drive means attached to the frame, a guide pulley located close to the grip pulley, the guide pulley being capable of guiding the rope under tension in the groove of the grip pulley, and a clamping pulley exerting pressure on the rope toward the grip pulley at the slack strand. The guide pulley and the clamping pulley are arranged close to one another in the first region of the frame so as to wrap the rope around the grip pulley over at least half of the circumference of the latter, and the lifting rope exits from the grip pulley at the first region of the frame.

### FIELD OF THE INVENTION

The present invention relates to a rope access device for moving along a rope, and in particular to a rope access device to which a user can anchor him/herself to climb up and down a rope.

### BACKGROUND OF THE INVENTION

The invention relates to the field of rope access devices and in particular of rope access devices comprising a grip pulley. Rope access devices with a grip pulley must not be confused with rope access devices with a drum or the like. This is because rope access devices with a grip pulley have the characteristic of being usable with ropes of unlimited length due to the principle of the rope being retained by being gripped within a single groove of the grip pulley in which the rope is wrapped around less than one turn.

Such rope access devices have been developed for professional, safety and sporting purposes: access to building façades, masts for wind turbines or ships, working areas in lift shafts or silos, mountain rescue, etc. Compared to other rope access devices, they offer the following advantages:
no height limit
possibility of moving along the rope and therefore accompanying the load.

These rope access devices may have up to three functions: a lock function, which allows the rope access operator to be positioned and held on the rope in a desired position, an ascent function, which allows the rope access operator to ascend the rope vertically, and/or a descent function, which allows the rope access operator to descend the rope at a speed automatically controlled by the device until a desired position is reached.

At present, few rope access devices are capable of performing these three functions without the user directly handling the rope. Furthermore, these rope access devices are generally bulky and therefore ill-suited for use as a self-contained portable unit, attached directly to the rope access operator's harness.

### OBJECT OF THE INVENTION

One object of the present invention is to provide a rope access device which is highly compact and capable of all three lock, ascent, and descent functions.

### General Description of the Invention

The present invention proposes a rope access device according to claim 1 for moving along a rope. It comprises a frame having, in service, a first region facing toward a portion of the rope under tension, a grip pulley mounted on said frame and comprising on the periphery thereof a groove enabling the rope to be hauled by grip, the grip pulley being coupled to rotational drive means attached to the frame, a guide pulley located close to said grip pulley, the guide pulley being capable of guiding the rope under tension in the groove of said grip pulley, and a clamping pulley exerting pressure on the rope toward said grip pulley at the slack strand.

According to the invention, the guide pulley and the clamping pulley are arranged close to one another in the first region of the frame so as to wrap the rope around the grip pulley over at least half of the circumference of the latter, and the rope exits from the grip pulley at the first region of the frame.

Furthermore, the clamping pulley is configured to clamp the rope in the bottom of the groove of the grip pulley and to eject the slack strand from the groove of the grip pulley.

By wrapping the rope around the grip pulley over at least half of the circumference of the latter, and by causing the rope to enter and exit at the first region of the frame, the design according to the invention ensures that the rope remains at the bottom of the groove of the grip pulley over a sufficient wrap length to ensure grip. Furthermore, the fact that the rope always surrounds the part of the grip pulley included in a second region of the frame, thanks to the clamping and guide pulleys arranged in the first region of the frame, is favorable in safety terms. It will also be noted that the system is extremely simple, requiring just three pulleys.

The design of the rope access device is thus simple, compact, safe, and can be used as an autonomous portable unit.

The rope access device advantageously provides all three locking, ascent, and descent functions. It allows the user to lock onto the rope, ascend, and descend at a controlled speed, and can be motorized to reduce the physical effort required to reach the working position. The rope access device requires no manual action to extract the rope from the grip pulley. The rope access operator therefore has one hand free in all circumstances, it then being possible for the other hand, inter alia, to control the speed of ascent or descent thanks to a control member.

The rope access device makes it possible to ascend and descend a rope of unlimited length. The grip pulley comprises a single groove in which the rope is wrapped around less than one turn (i.e., less than 360°).

It will be understood that the rope access device was designed for “semi-static” ropes of approximately 8 to 12 mm, in particular 10 to 11 mm, in diameter, which results in the integration of a clamping pulley which also performs an extraction function, ejecting the rope outward and eliminating the tendency to jamming or to manual extraction of the slack strand.

Furthermore, the design of the rope access device according to the invention, which uses a clamping pulley, also performs an extraction function because it forces the rope to remain at the bottom of the groove of the grip pulley until it has been deflected by an extraction finger and then ejects it from the frame. The clamping pulley locks the rope in the grip pulley when there is no drive, eliminating the need for a specific locking device. Combining the two functions of clamping and extraction from the pulley furthermore enables a large wrap angle of up to approximately 340° of the rope over the grip pulley, so increasing the lifting force.

In order to be driven, the grip pulley is preferably mounted on a shaft coupled to a manual or motor-powered drive mechanism, generally via a reducing gearbox. The motor may be an electric motor or heat engine.

The motor control makes it possible to cause the grip pulley to rotate in both directions of rotation, so enabling the user to control the ascent or descent of the rope access device on the rope.

The design of the rope access device furthermore enables great compactness, making it suitable for use as an autonomous portable unit attached directly to a rope access operator's harness.

The rope access device advantageously comprises an anchoring point for attaching a flexible link (strap) to the rope access operator's harness.

The clamping pulley is retractable, which makes it possible to wrap the rope around the grip pulley over a continuous portion of the rope and not just at the end of the rope.

The grip pulley is preferably of the V groove type and grip may be enhanced by a relief pattern on the sidewalls of the groove. The term V groove should be interpreted broadly, the sidewalls being inclined such that the groove narrows toward the bottom, which need not be V-shaped but may generally be curved or flat.

In practice, the rope and the grip pulley are selected to suit one another.

In order to limit rope wear while keeping the rope access device compact, a pulley of at least 80 mm wrap diameter will advantageously be selected and the target wrap coefficient will be of the order of 8.

A wrap diameter or radius is taken to mean the internal diameter or radius of the pulley groove.

In particular, the wrap diameter of the grip pulley will preferably be determined relative to the diameter of the rope, so as to achieve force efficiency no greater than 85%.

The force efficiency η_{b} (in static bending) is calculated according to the equation:

$${η}_{b} = 1 - \frac{0.59}{\sqrt[3]{{( \frac{D}{d} )}^{2}}}$$

where D is the wrap diameter of the grip pulley and d the diameter of the rope.

Thus, given a rope of 11 or 11.5 mm in diameter, a grip pulley with a wrap diameter of the order of 90 to 100 mm, or larger, will be used.

According to some variants, the distance between the center of the guide pulley and the center of the grip pulley is between 1.6 and 2 times the wrap radius of the grip pulley.

According to some variants, the grip pulley, the guide pulley, and the clamping pulley are arranged so as to define a triangle having an angle of 45±2° at the grip pulley, an angle of 58±2° at the guide pulley, and/or an angle of 76±2° at the clamping pulley.

According to some variants, the rope has a diameter of between 8.0 and 12.0 mm, in particular of 10.0, 10.5, 11.0 or 11.5 mm, and the grip pulley has a wrap diameter of at least 8.0, 9.0 or 10.0 cm.

According to some variants, the guide pulley and the clamping pulley are positioned in such a manner that the rope is engaged in said groove over an angle of at least 200°, preferably at least 280°, and more preferably between 320° and 340°.

According to some variants, said groove is defined by two sidewalls, the spacing of which gradually reduces as a function of depth, so forming a V groove, the V groove preferably having an aperture angle of 25 to 35°, and the sidewalls of the groove preferably have a relief pattern for increased grip, preferably trapezoidal ribs inclined in the direction of the taut strand.

According to some variants, the grip pulley has a diameter of at least 80 mm and a wrap coefficient of the order of 8.

According to some variants, in use, the first region is the upper part of the frame, the second region being the lower part.

According to some variants, the rotational drive means comprise a motor coupled via a reducing gear to a shaft on which is mounted said grip pulley.

According to some variants, the rope access device comprises a control member configured to drive said drive means, the control member preferably comprising a joystick capable of remotely controlling said drive means.

According to some variants, a mechanical service brake which is normally closed at rest is provided.

According to some variants, the grip, clamping and guide pulleys are circumscribed by the frame and covered by a first cover, and/or the drive means is covered by a second cover, and preferably comprising a handle.

According to some variants, the drive means is an electric motor, further comprising a battery and a display device capable of displaying a state of charge of the battery.

These and other embodiments are set out in the appended dependent claims.

The term “rope” should be interpreted broadly and may include any kind of rope made from synthetic, natural or metallic fibers, etc.

### BRIEF DESCRIPTION OF THE DRAWINGS

Other details and features of the invention will emerge from the following detailed description of one embodiment, provided by way of illustration with reference to the appended drawings, in which:

FIG. 1 is a front view of the rope access device according to the invention;

FIGS. 2a and 2b are isometric views of the internal mechanism of the rope access device according to the invention;

FIG. 3 is a perspective view of a grip pulley;

FIG. 4 shows a plurality of views of an extraction finger;

FIG. 5 is an isometric view of the rope access device according to the invention; and

FIG. 6 is a view of the rope access device in use.

### DETAILED DESCRIPTION WITH REFERENCE TO THE FIGURES

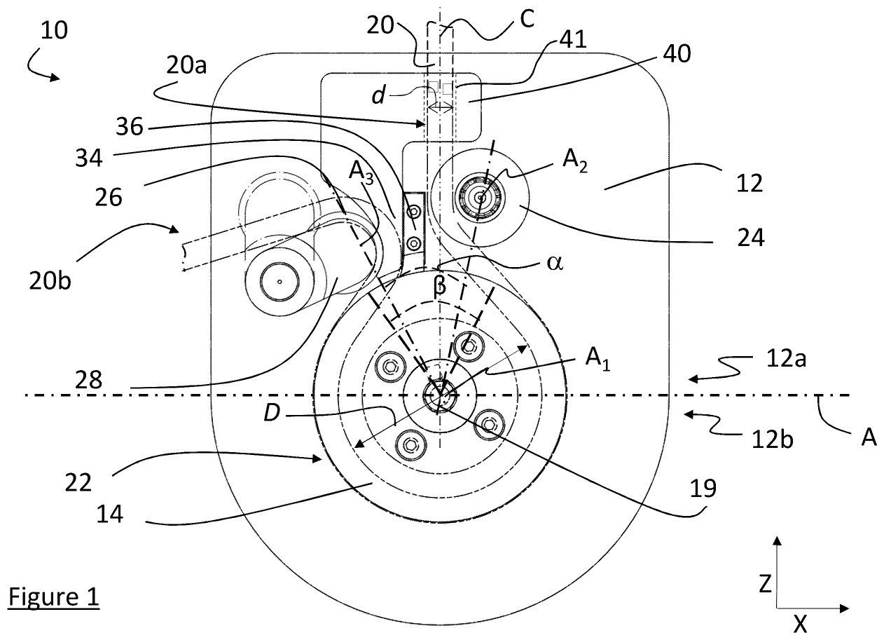

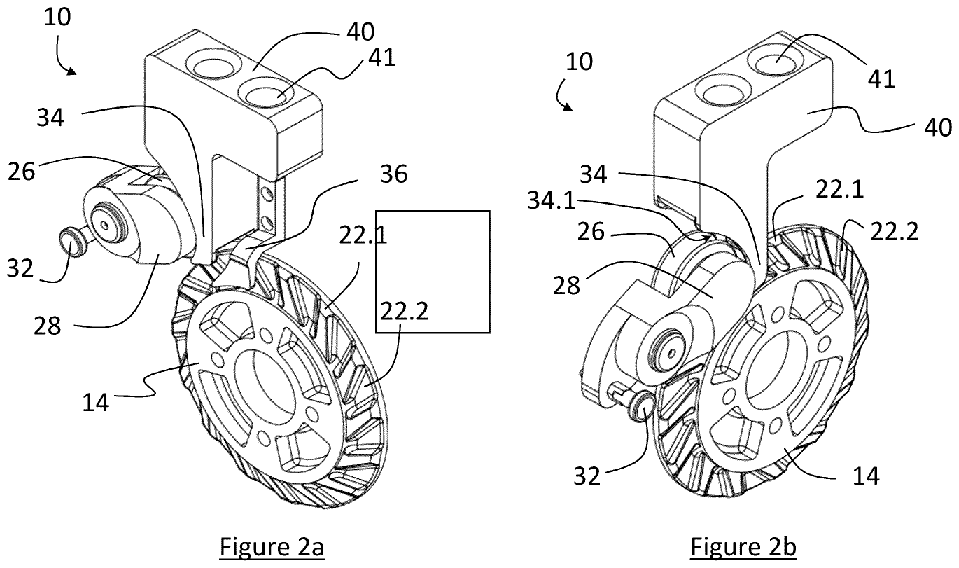

FIG. 1 shows a front view of one embodiment of the present rope access device 10, the rope (also referred to as lifting rope or lifting strand) being designated 20. FIGS. 2a and 2b show isometric views of the internal mechanism of said device 10. The device 10 comprises a frame 12 on which is mounted a grip pulley 14 (also denoted drive pulley) comprising on the periphery thereof a (single) groove 22 enabling the rope 20, in particular a synthetic rope, to be driven by grip. For the purpose of rotation, the grip pulley 14 is attached to a shaft 19 to which it is connected for rotation. The frame 12 is here formed by a metal (e.g., stainless steel or aluminum) plate of a thickness of between 8 and 12 mm, a height of 200 mm and a width of 175 mm. The shaft 19 is generally part of a drive means coupled to the grip pulley 14 via said shaft, as will be seen below. In the variant illustrated in FIG. 1, the shaft 19 is accommodated in a bearing which passes through the thickness of the frame 12, the grip pulley therefore being located on the front of the frame, and the drive means being positioned to the rear of the frame, and therefore not visible in FIG. 1.

FIG. 1 shows the rope access device 10 in its service/use position, in which it can be seen that there is a taut strand 20a of the rope 20 arriving from the top of the rope access device 10 (the opposite end of the taut strand 20a being attached to a support which is not visible), and a slack strand 20b being expelled toward the side. The taut strand 20a arrives at the upper region 12a of the frame, and the slack strand 20b likewise exits at the upper region 12a of the frame.

The notion of upper region is relative to a horizontal plane A, shown in FIG. 1, passing through the center (marked A₁) of the grip pulley 14 and the shaft 19, the upper region 12a of the frame being that above the plane A, and the lower region 12b of the frame being that below plane A. Advantageously, the grip pulley 14 is centered with regard to the rope access device 10, i.e., the axis of rotation A₁ of the grip pulley 14 passes through the center of gravity of the rope access device 10.

A single guide pulley 24 is provided to guide the rope 20 under tension from the upper region 12a of the frame toward the grip pulley 14. The taut strand 20a of the rope 20 arriving from the top passes via the guide pulley 24, which transfers the taut strand 20a toward the grip pulley 14. The rope 20 then forms a loop around the grip pulley 14 and exits from the latter downstream of a clamping pulley 26 which exerts a pressure on the rope 20 toward the bottom of the groove 22. The clamping pulley 26 and the guide pulley 24 are freely rotatably mounted.

The axis of rotation A₃ of the clamping pulley 26 is stationary in use, but this pulley 26 is mounted retractably by way of an arm 28. One end of the arm 28 rotatably carries the clamping pulley 26 and is itself attached pivotably in the middle thereof on the frame 12, the pivoting movement being in a plane perpendicular to the shaft 19. A peg 32 makes it possible to limit the displacement of the arm 28 to lock the clamping pulley 26 close to the grip pulley 14 when the device is in use (configuration of FIG. 1). In operation, the clamping pulley 26 therefore normally has a stationary position. The retracted position of the clamping pulley 26 (when the peg 32 is withdrawn and the arm 28 pivoted back) is illustrated in broken lines in FIG. 1, said position facilitating placement of the rope 20.

After the clamping pulley 26, the slack strand 20b of the rope 20 is ejected from the groove 22 of the grip pulley 14. Preferably, a first “extraction” guide 34 is positioned directly after the clamping pulley 26, defining a curved guide surface 34.1 which cooperates with the clamping pulley 26, so as to assist in extraction of the slack strand 20b from the groove 22. A curved extraction finger 36 is positioned close to the first guide 34 and extends from the upper end thereof partially into the groove 22 of the grip pulley to facilitate extraction of the rope 20. Thus, the first guide 34 and the extraction finger make it possible to extract the slack strand 20b from the rope access device 10. There is no need to ballast the slack strand 20b with a weight to extract it from the grip pulley 14.

A second guide 40 is positioned at the inlet of the guide pulley 24 and defines an insertion channel 41 for the rope 20, the channel defining a straight passage tangential to the guide pulley 24 and extending along an axis C passing through the center A₁ of the grip pulley 20. The first and second guides 34, 40 here form a single member composed of two half-pieces, one mounted on a first cover 44, and the other attached to the frame 12, so that it is not necessary to thread the rope 20 from one of the ends thereof.

In such a rope access device 10 with a grip pulley 14, the hauling force depends on the wrap angle of the rope 20 in the groove 22 of the grip pulley 14 and the coefficient of grip of the rope 20 in the groove 22, as well as on the force exerted by the clamping pulley 26 on exit from the grip pulley 14. Appropriate sizing of the grip pulley 14 and of the clamping pulley 26, taking account of the service load, therefore makes it possible to produce a rope access device 10 which has a sufficient lifting force and does not require an additional brake at standstill.

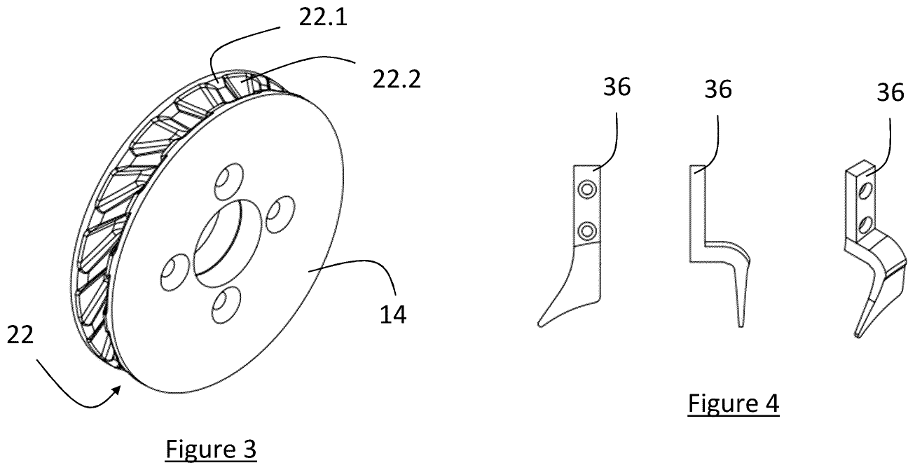

In order to improve the grip of the rope 20 in the groove 22, the sidewalls 22.1 thereof are preferably V-shaped, as shown in FIGS. 2a, 2b and 3. Grip is still further increased by protuberances, here trapezoidal ribs 22.2 inclined in the direction of the taut strand 20 and distributed regularly at the bottom of the groove 22. The orientation of these ribs 22.2 makes it possible to reduce the pressure on the rope 20 at the clamping pulley 26, so facilitating the extraction thereof.

Grip is further controlled by appropriate groove/rope sizing, the bottom of the groove 22 having a diameter slightly less than that of the rope, for example 0.7 to 0.9, preferably between 0.7 and 0.8, times the diameter of the rope. In other words, the bottom of the groove 22 is not of a pointed V shape, but rather has a dished or flat bottom. The aperture angle of the groove 22 (between the two sidewalls) may be selected between 15 and 35°, preferably between 25 and 30°. The thickness of the protuberances may also be adjusted.

Another parameter which influences grip is the wrap angle β over which the rope is engaged in the groove 22 of the grip pulley 14. It is the respective positions of the guide pulleys 24 and clamping pulleys 26 which determine said wrap angle β. The wrap angle β is greater than 200°, preferably greater than 270° and in particular between 32° and 359°. As can be seen in FIG. 1, the clamping and guide pulleys are positioned close to one another, separated by the first guide 34, so enabling a large wrap angle β of up to 340°. The various parameters influencing grip will be sized with care since they are also factors in wear of the rope 20. The target wrap coefficient (ratio of wrap diameter to rope diameter) is preferably of the order of 8, with a grip pulley 14 having a wrap diameter of at least 80 mm and a semi-static rope approximately 10 mm in diameter, or at least 90 mm for a rope of 11 mm or 11.5 mm. As can be seen in FIG. 1, the present rope access device 10 is compact, the various pulleys being mounted on the frame in the same plane.

Preferably, the grip pulley 14, the guide pulley 24, and the clamping pulley 26 are arranged so as to define a triangle having an angle α of 45±2° at the grip pulley 14, the guide pulley 24 being configured so as to hold the taut strand 20a along the axis C passing through the center A₁ of the grip pulley (center of gravity) and the insertion channel 41.

This optimized configuration ensures good hauling of the rope 20 by the grip pulley 14 and facilitates the extraction thereof. This configuration furthermore ensures that the rope 20 is neither too tight, which would increase wear of the rope 20, nor too loose, which would increase the risk of the rope 20 slipping. Simulations have predicted an estimated life for the rope 20 of greater than 200-500 cycles.

Furthermore, the distance between the center A₂ of the guide pulley 24 and the center A₁ of the grip pulley 14 is advantageously at least 1.6 to 2 times the wrap radius of the grip pulley 14, so limiting the forces exerted on the guide pulley 24.

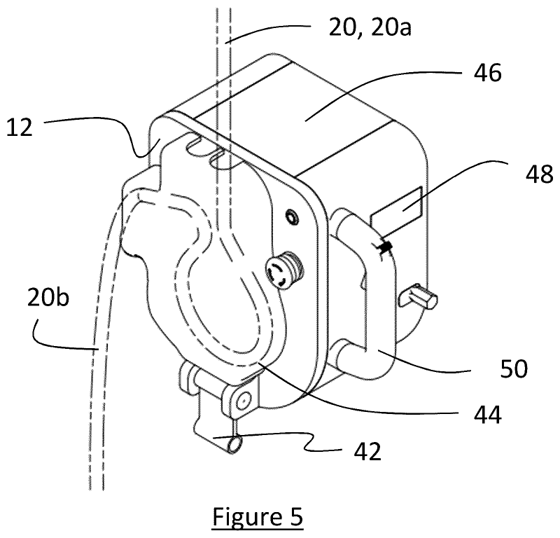

FIG. 5 shows an isometric view of the rope access device according to the invention. For user safety, the rope access device 10 comprises a first cover 44 covering the frame 12 and comprising apertures for the rope 20. The rope access device 10 also comprises a drive means 46 covered by a second cover (also denoted 46). This drive means comprises a motor coupled at its output to a reducing gear (not shown). The shaft 19 which drives the grip pulley 14 may be part of the reducing gear or be coupled thereto. The motor/reducing gear assembly is securely attached to the frame 12 and covered by the second cover. As is usual in lifting applications, the motor has a service brake, i.e., a mechanical brake which is normally closed at rest. An electric motor associated with a battery may be used to obtain an embodiment in the form of an autonomous rope access device. The rope access device 10 may then also comprise a screen 48 to display at least the state of charge of the battery. This combination forms a compact, easy-to-use assembly which a user can carry by a handle 50.

The device may advantageously be controlled by way of a control member, for example of the joystick type (not shown), which may be wired or wireless.

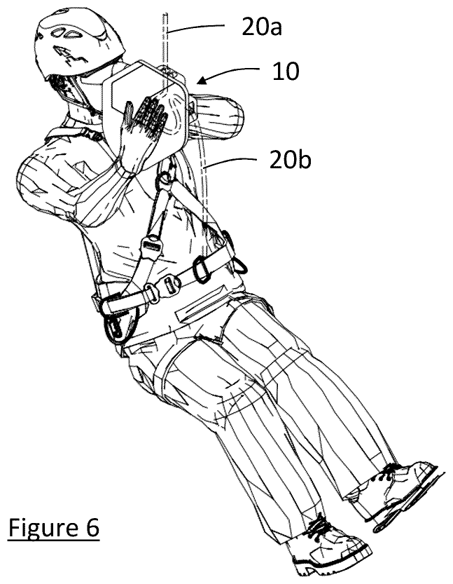

Reference sign 42 indicates a lug (linked to the frame 12) which forms an anchoring point or a support for an anchoring point intended to receive a carabiner or other link by which a user can attach a harness, lanyard or load of some kind. Alternatively, the lug 42 may form an anchoring point for a rigid frame comprising a seat which enables the user to be seated rather than suspended from the rope access device, as shown in FIG. 6. A person skilled in the art will furthermore be capable of developing any other solution to form a structure suspended from, or supported by, the present rope access device.

### Example

In one exemplary embodiment, the following parameters have been determined for a rope 11.5 mm in diameter and with reference to the configuration of FIG. 1.

A grip pulley with a wrap diameter of 100 mm, giving a force efficiency η_{b}=86%.

The angle α is 45.6°.

The vertical distance (parallel to axis C) between axis A₁ and the axis A₂ of the guide pulley 24 is 87 mm.

The vertical distance (parallel to axis C) between axis A₁ and axis A₃ of the clamping pulley 26 is 63 mm.

This configuration enables operation with a user weighing up to 200 kg.

1. A rope access device for moving along a rope comprising:
a frame having, in service, a first region facing toward a portion of the rope under tension;
a grip pulley mounted on said frame and comprising on the periphery thereof a groove enabling the rope to be hauled by grip, the grip pulley being coupled to rotational drive means attached to the frame;
a guide pulley located close to said grip pulley, the guide pulley being capable of guiding the rope under tension in the groove of said grip pulley; and
a clamping pulley exerting pressure on the rope toward said grip pulley at the slack strand;
wherein the guide pulley and the clamping pulley are arranged close to one another in the first region of the frame so as to wrap the rope around the grip pulley over at least half of the circumference of the latter;
wherein the rope exits from the grip pulley at the first region of the frame; and
wherein the clamping pulley is configured to clamp the rope in the bottom of the groove of the grip pulley and to eject the slack strand from the groove of the grip pulley.

2. The rope access device according to claim 1, further comprising an anchoring point for a flexible link or a rigid structure capable of supporting a user or a load, said anchoring point being linked to the frame in a second region of the latter.

3. The rope access device according to claim 1, comprising an extraction means, arranged in the first region of the frame between the clamping pulley and the guide pulley so as to extract the rope from the groove of the grip pulley, the extraction means comprising an extraction finger extending into the groove of the grip pulley.

4. The rope access device according to claim 1, comprising an extraction guide positioned between the guide pulley and the clamping pulley, said first guide defining a curved guide surface which cooperates with the clamping pulley so as to assist in extraction of the slack strand.

5. The rope access device according to claim 1, comprising an inlet guide positioned at the inlet of the guide pulley and defining an insertion channel for the rope, the channel being tangential to the guide pulley and extending along an axis passing through the center of the grip pulley, the inlet guide and the extraction guide being formed in one piece.

6. The rope access device according to claim 1, wherein said clamping pulley is retractably mounted on an arm that pivots relative to said frame, cooperating with locking means for locking this arm in a use position, wherein, in the use position, the clamping pulley clamps the rope in the bottom of the groove of the grip pulley and wherein, in a retracted position, the clamping pulley is withdrawn to permit placement or release of the rope.

7. The rope access device according to claim 1, wherein the axis of rotation of the grip pulley passes through the center of gravity of the rope access device.

8. The rope access device according to claim 1, wherein the distance between the center (A₁) of the guide pulley and the center (A₂) of the grip pulley is between 1.6 and 2 times the wrap radius of the grip pulley.

9. The rope access device according to claim 1, wherein the grip pulley, the guide pulley, and the clamping pulley are arranged so as to define a triangle having an angle of 45±2° at the grip pulley, an angle of 58±2° at the guide pulley, and/or an angle of 76±2° at the clamping pulley.

10. The rope access device according to claim 1, wherein the device has a force efficiency η_{b} greater than 85% satisfying the formula
$${η}_{b} = 1 - \frac{0.59}{\sqrt[3]{{( \frac{D}{d} )}^{2}}}$$
where D is the wrap diameter of the grip pulley and d the diameter of the rope.

11. The rope access device according claim 1, wherein the rope has a diameter of between 8.0 and 12.0 mm, and the grip pulley has a wrap diameter of at least 8.0 cm.

12. The rope access device according to claim 1, wherein said guide pulley and said clamping pulley are positioned in such a manner that the rope is engaged in said groove over an angle of at least 200°.

13. The rope access device according to claim 1, wherein said groove is defined by two sidewalls, the spacing of which gradually reduces as a function of depth, so forming a V groove, the V groove having an aperture angle of 25 to 35°, and the sidewalls of the groove have a relief pattern for increased grip, comprising trapezoidal ribs inclined in the direction of the taut strand.

14. The rope access device according to claim 1, wherein the grip pulley has a diameter of at least 80 mm and a wrap coefficient of the order of 8.

15. The rope access device according to claim 1, wherein, in use, the first region is the upper part of the frame, the second region being the lower part.

16. The rope access device according to claim 1, wherein the rotational drive means comprise a motor coupled via a reducing gear to a shaft on which is mounted said grip pulley.

17. The rope access device according to claim 1, comprising a control member configured to control said drive means, the control member comprising a joystick capable of remotely controlling said drive means.

18. The rope access device according to claim 1, comprising a mechanical service brake which is normally closed at rest.

19. The rope access device according to claim 1, wherein the grip, clamping and guide pulleys are circumscribed by the frame and covered by a first cover and/or wherein the drive means is covered by a second cover, and comprising a handle.

20. The rope access device according to claim 1, wherein the drive means is an electric motor, further comprising a battery and a display device capable of displaying a state of charge of the battery.
